(19) United States
(12) Patent Application Publication
(10) Pub. No.: US 2026/0300001 A1
(43) Pub. Date: Oct. 1, 2026

(54) COORDINATING INTERACTIONS WITH HETEROGENOUS MACHINE LEARNING AGENTS

(71) Applicant: Microsoft Technology Licensing, LLC, Redmond, WA (US)

(72) Inventors: Lindsay Gray GREENE, Seattle, WA (US); Cong CHEN, Samammish, WA (US); Sheikh Sadid AL HASAN, Weymouth, MA (US); Aarti Kumari DWIVEDI, Conroe, TX (US); Miguel Oscar DI LUCA, Vancouver (CA); Vivek GUPTA, Groton, MA (US); Jian ZHANG, Bellevue, WA (US); Xiangyang CAO, Redmond, WA (US); Wilberto W. MONTOYA, Coral Springs, FL (US); Emmanuel Aboah BOATENG, Atlanta, GA (US)

(73) Assignee: Microsoft Technology Licensing, LLC, Redmond, WA (US)

(21) Appl. No.: 19/096,264

(22) Filed: Mar. 31, 2025

(51) Int. Cl. G06F 9/48; G06F 9/451; G06F 18/2415

(52) U.S. Cl. CPC G06F 9/4881; G06F 9/451; G06F 18/2415

(57) ABSTRACT

This document relates to facilitating interactions between a user and multiple agents, such as agents that provide different generative machine learning capabilities. In certain disclosed implementations, user input is received and two or more agents are selected to perform a particular task for the user. Then, interactions with the agents are coordinated on behalf of the user based on agent definitions of the selected agents. A result of the particular task is received and provided to the user. For instance, the user input can be received via a chat interface that allows the user to conduct a single chat session that involves the particular task being performed by multiple agents, thus giving the user the appearance of interacting with a single agent.

### BACKGROUND

In recent years, generative machine learning models have demonstrated tremendous capability at generating content. For instance, generative language models can generate text to summarize existing documents, help users draft new documents, and conduct natural language conversations with users at a very high level. As another example, generative image models can generate realistic and/or aesthetically-pleasing images from natural language prompts, and they can also modify existing images by restyling them and/or adding objects.

In some cases, users can access generative machine learning models directly. For instance, users can draft their own prompts, specify formats for model output, check generated content for hallucinations manually, etc. However, this can involve a great deal of effort, and many users lack the expertise to effectively utilize generative machine learning models directly. Another approach involves providing an agent that interfaces between a user and a generative machine learning model. This can be helpful because agents can directly interface with the generative machine learning model on behalf of the user. However, agents tend to have different capabilities and technical limitations, and agents also may have limited ability to directly interact with other agents.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for coordinating user interactions with agents that have machine learning capabilities. One example includes a computer-implemented method that can include providing an agent registry, the agent registry including agent definitions identifying respective characteristics of a plurality of agents. The method can also include receiving user input from a user, the user input relating to a particular task requested by the user. The method can also include responsive to receiving the user input, selecting two or more agents to perform the particular task based at least on respective agent definitions of the two or more selected agents in the agent registry. The method can also include coordinating interactions with the two or more selected agents in accordance with the respective agent definitions, wherein the interactions relate to the particular task. The method can also include receiving a result associated with the particular task from an individual selected agent. The method can also include responding to the user with the result.

Another example entails a system that includes a processor and a storage medium storing instructions. When executed by the processor, the instructions can cause the system to provide an agent registry, the agent registry including agent definitions identifying respective characteristics of a plurality of agents. The instructions can also cause the system to receive user input from a user, the user input relating to a particular task requested by the user. The instructions can also cause the system to, responsive to receiving the user input, select two or more agents to perform the particular task based at least on respective agent definitions of the two or more selected agents in the agent registry. The instructions can also cause the system to coordinate interactions with the two or more selected agents in accordance with the respective agent definitions, wherein the interactions relate to the particular task. The instructions can also cause the system to receive a result associated with the particular task from an individual selected agent. The instructions can also cause the system to respond to the user with the result.

Another example includes a computer-readable storage medium storing executable instructions which, when executed by a processor, cause the processor to perform acts. The acts can include providing an agent registry, the agent registry including agent definitions identifying respective characteristics of a plurality of agents. The acts can also include receiving user input from a user, the user input relating to a particular task requested by the user. The acts can also include responsive to receiving the user input, selecting two or more agents to perform the particular task based at least on respective agent definitions of the two or more selected agents in the agent registry. The acts can also include coordinating interactions with the two or more selected agents in accordance with the respective agent definitions, wherein the interactions relate to the particular task. The acts can also include receiving a result associated with the particular task from an individual selected agent. The acts can also include responding to the user with the result.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example architecture for providing a gateway to access multiple agents, consistent with some implementations of the present concepts.

FIG. 2 illustrates an example graph data structure representing relationships among multiple agents, consistent with some implementations of the present concepts.

FIGS. 3A, 3B, 3C, and 3D illustrate examples of various user interaction topologies that can be implemented, consistent with some implementations of the present concepts.

FIGS. 4A, 4B, 4C, 4D, and 4E illustrate an example user experience that can be provided, consistent with some implementations of the present concepts.

FIG. 5 illustrates an example evaluation workflow for evaluating agent interactions, consistent with some implementations of the present concepts.

FIG. 6 illustrates an example of a system in which the disclosed implementations can be performed, consistent with some implementations of the disclosed techniques.

FIG. 7 illustrates an example of a method consistent with some implementations of the present concepts.

FIG. 8 illustrates an example generative language model, consistent with some implementations of the present concepts.

FIG. 9 illustrates an example generative image model, consistent with some implementations of the present concepts.

FIG. 10 illustrates an example computer vision model, consistent with some implementations of the present concepts.

FIG. 11 illustrates an example vision language model, consistent with some implementations of the present concepts.

### DETAILED DESCRIPTION

### Overview

As noted above, using an agent as an intermediary between a user and a generative machine learning model can be very helpful. Agents can generate structured prompts for users that effectively represent user intent, handle context window limitations, provide user-friendly interfaces to extract information from users and provide output to users, etc. However, in some cases, a user may wish to perform a relatively complex task that involves several subtasks. If the same agent is well-suited to perform each of the subtasks, this approach can provide a satisfactory experience for the user.

In other cases, however, a user might wish to perform a task that has subtasks that lend themselves to capabilities of different agents. For instance, consider a user that wishes to perform a first subtask that involves complex analytical reasoning, and a second subtask that involves a back-and-forth dialog. In some cases, an agent well-suited to the first subtask might have relatively high latency and/or somewhat limited dialog capabilities, while another agent well-suited to the second subtask might be relatively less capable of the complex analytical reasoning involved in the first subtask.

One option would be for the user to decide for themselves which agents to use for which subtasks. The user could then interact independently with the agents that they choose. However, this approach is lacking for several reasons. For instance, user input to one of the agents and/or output of that agent might provide useful context for the other agent, and the user may not recognize that it could be helpful for them to share information among the agents. Furthermore, the user would typically have to access separate entry points for each agent, potentially using different applications or browser windows/tabs, separate chat histories, etc.

Another plausible approach would involve hard-coding a set of rules for each combination of subtasks. For instance, a set of rules could be defined that selects a specific set of agents to use for specific subtasks. Then, programmatic logic could be defined to share information with the selected agents in a particular order. However, this approach is quite inflexible and would likely involve revising the programmatic logic each time agent capabilities were to change. Furthermore, as the number of available agents increases, it becomes computationally infeasible to consider every possible combination of agents for every possible combination of subtasks.

The disclosed implementations offer techniques for providing a gateway that serves as a single point of entry for users to interface with various agents having different capabilities. For instance, the disclosed implementations can provide a registry of agent capabilities, limitations, and other metadata. When users access the gateway, the registry can be employed to select agents to assist the user based on the user's intent. Then, the gateway can coordinate interactions with the user and the selected agents to accomplish a task for the user. The gateway provides a unified chat history that abstracts the user away from the underlying agent interactions and provides a seamless experience for the user. In some cases, the user may not even realize they are interacting with multiple agents. Thus, users can focus on communicating their intent in a natural way via the gateway, and the gateway can handle agent selection and interactions on behalf of the user.

### Machine Learning Overview

There are various types of machine learning frameworks that can be trained to perform a given task. Support vector machines, decision trees, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “agent,” as used herein, refers to an entity that can perform at least one task or subtask on behalf of a user by interacting with one or more models. The model(s) can be hard-coded or implemented using machine learning and can be part of the agent itself or implemented as a separate entity (e.g., as a separate software application or library, on a different device, etc.). The term “task” refers to any processing that a user requests via user input, such as text, voice, gestures, eye gaze, etc. The term “subtask” refers to any portion of a larger task. Thus, one agent can perform an entire task for a user that involves one or more subtasks, or different agents can cooperatively perform a task for a user by implementing separate subtasks relating to that task.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-40, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image. The term “suggested” refers to output predicted by a generative machine learning model, e.g., suggested tags, suggested values, and suggested images respectively refer to tags, values, and images predicted by a generative machine learning model.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Gateway Architecture

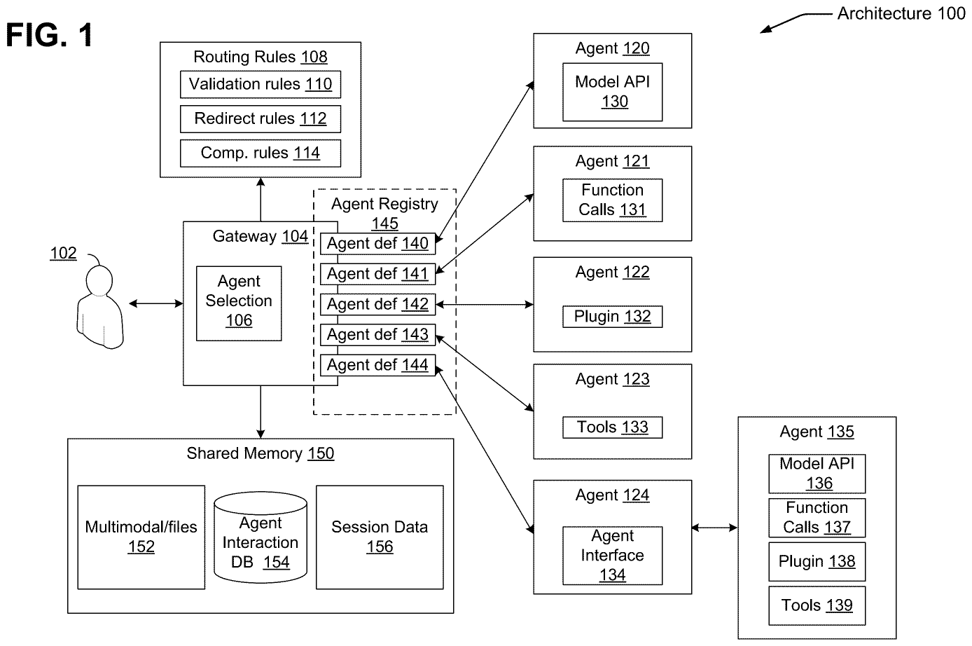

FIG. 1 shows an example architecture 100 for providing user access to heterogonous agents with varying capabilities, such as generative machine learning capabilities. A user 102 accesses a gateway 104 by providing input relating to a task. For instance, the input can be provided via text entry, speech, gestures, mouse clicks, touch inputs, gaze, etc. The input can also specify one or more subtasks associated with the task.

The gateway 104 performs agent selection 106 to determine selected agents to invoke to perform the task on behalf of the user. For instance, agent selection can involve inferring user intent relating to the task. In some cases, an intent classifier could determine that the user's intent is to conduct a dialog, request generation of an image, chart, or graph, conduct an analysis of a data set, generate programming code, etc. As discussed more below, in some implementations, the agent selection involves employing an agent graph to map the user intent to one or more selected agents.

The gateway 104 can also employ routing rules 108 to coordinate interactions with the selected agents. For instance, the routing rules can include validation rules 110, redirect rules 112, and compliance rules 114. The routing rules can specify that certain types of requests are routed to certain agents. The redirect rules can specify when certain requests are redirected from one agent to another. Compliance rules can specify that requests and/or agent outputs comply with various criteria, e.g., for responsible artificial intelligence usage.

The gateway 104 can select and invoke any of agent 120, agent 121, agent 122, agent 123, and/or agent 124 to perform a given task or subtask. Agent 120 can provide a model application programming interface 130 that allows the gateway to directly interact with one or more generative models. Agent 121 can provide one or more function calls 131 via a prompt to one or more generative models, where the generative models have the capability to invoke individual function calls. Agent 122 can utilize one or more plugins 132 with one or more generative models, where the plugins allow the one or more generative models to integrate with other services or data sources in addition to allowing the generative models to call functions on those services or data sources. Agent 123 can use one or more tools 133 to interact with one or more generative models, where the tools can provide prompts that are composed together to implement complex reasoning. Agent 124 can implement an agent interface 134 that allows agent 124 to interact with another agent 135, which can implement any of a model application programming interface 136, function calls 137, plugin 138, and/or tools 139.

Each agent can have a corresponding agent definition that conveys information about that agent's capabilities, endpoints for accessing that agent, context window limitations, communication templates, etc. For instance, agent 120 can have an agent definition 140, agent 121 can have an agent definition 141, agent 122 can have an agent definition 142, agent 123 can have an agent definition 143, and agent 124 can have an agent definition 144. Collectively, the agent definitions make up an agent registry 145.

The gateway 104 can use a shared memory 150 to store information relating to interactions with the various agents. For instance, the shared memory can have files 152, an agent interaction database 154, and/or session data 156. The files can include files provided by a user, obtained from an external system, and/or provided by one of the agents. The agent interaction database can store information relating to agent interactions, such as prompts input to the agents and/or output received from the agents. Session data 156 stores information relating to one or more user sessions, such as user input received from a user and/or responses that are output to the user via a chat or voice interface.

### Example Agent Graph

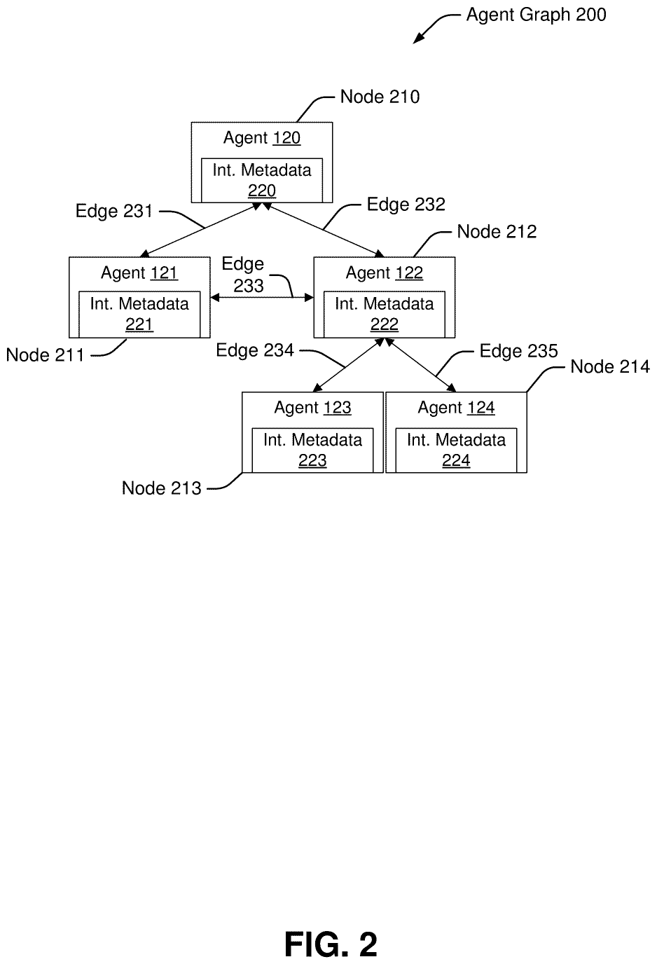

As mentioned above, one way for gateway 104 to implement agent selection 106 involves employing an agent graph. FIG. 2 shows an example agent graph 200. Node 210 represents agent 120 and includes interaction metadata 220 for agent 120, node 211 represents agent 121 and includes interaction metadata 221 for agent 121, node 212 represents agent 122 and includes interaction metadata 222 for agent 122, node 213 represents agent 123 and includes interaction metadata 223 for agent 123, and node 214 represents agent 124 and includes interaction metadata 224 for agent 124. Generally, the interaction metadata can include information relating to interactions between gateway 104 and one of the agents, and/or metadata relating to interactions among different agents.

Edges can convey relationships between individual agents. For example, edge 231 can indicate interoperability between agent 120 and agent 121, edge 232 can indicate interoperability between agent 120 and agent 122, edge 233 can indicate interoperability between agent 121 and agent 122, edge 234 can indicate interoperability between agent 122 and agent 123, and edge 235 can indicate interoperability between agent 122 and agent 124. Here, interoperability generally means either that two agents can interact directly without involvement of the gateway to coordinate the interactions, or the agents have complementary capabilities that allow the gateway to act as an intermediary to coordinate their interactions. Generally speaking, however, it can be useful for agents to interact with one another using the gateway as an intermediary, as this allows the gateway to utilize the agent definitions, rules, shared memory, etc. to ensure effective cooperation among agents.

As one example of how the gateway can coordinate interactions among agents with complementary capabilities, assume that agent 120 has computer vision capabilities and can output a single text classification for an input image. Further, assume that agent 121 has generative language capabilities and can provide details on the text classification. Here, the agents have the capability to operate together, in that the output of agent 120 can serve as a parameter used by agent 121. Thus, edge 231 can be created to connect these two agents based on these capabilities, e.g., as specified by their respective agent definitions.

In some cases, the respective edges can have corresponding weights that represent how effectively agents interoperate with one another. For example, assume that agent 120 is updated to support capabilities for recognizing multiple objects in a single image and generating textual captions representing spatial relationships of the objects in the image. Since these captions can provide additional information usable by the natural language generation capabilities of agent 121, edge 231 can have a corresponding weight increase in value based on the updated capabilities.

In some cases, updated agent capabilities can be provided via updated agent definitions, e.g., agent 120 may send a notification to the gateway 104 indicating that the agent has been updated to support recognizing multiple objects in a single image and generating textual captions representing spatial relationships of the objects in the image. In other capabilities, updated agent capabilities can be discovered via interactions with that agent, e.g., the first time that agent 120 generates captions for multiple objects instead of merely a text description for the image as a whole, the interaction metadata 220 for agent 120 can be updated to convey this additional capability.

### Example Topologies

Architecture 100 can be employed to support a wide range of user and agent interactions. Generally speaking, the gateway 104 can coordinate interactions among one or more users and one or more agents to assist the user with performing a particular task. The following describes a few agent interaction topologies that can be supported.

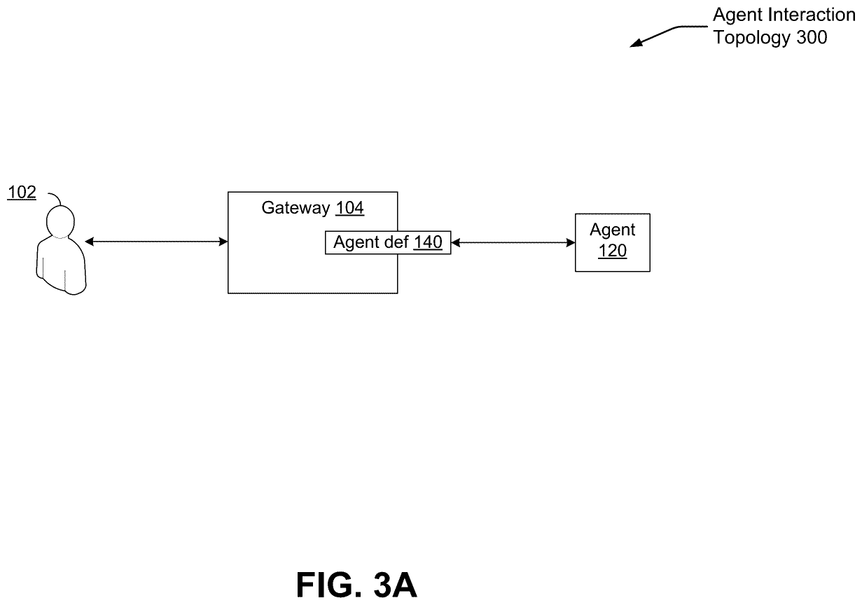

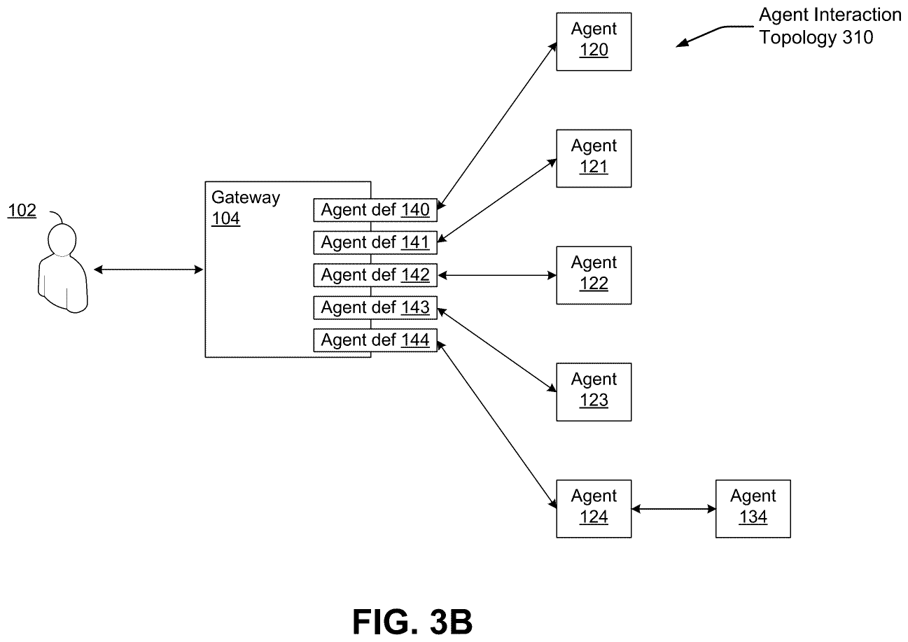

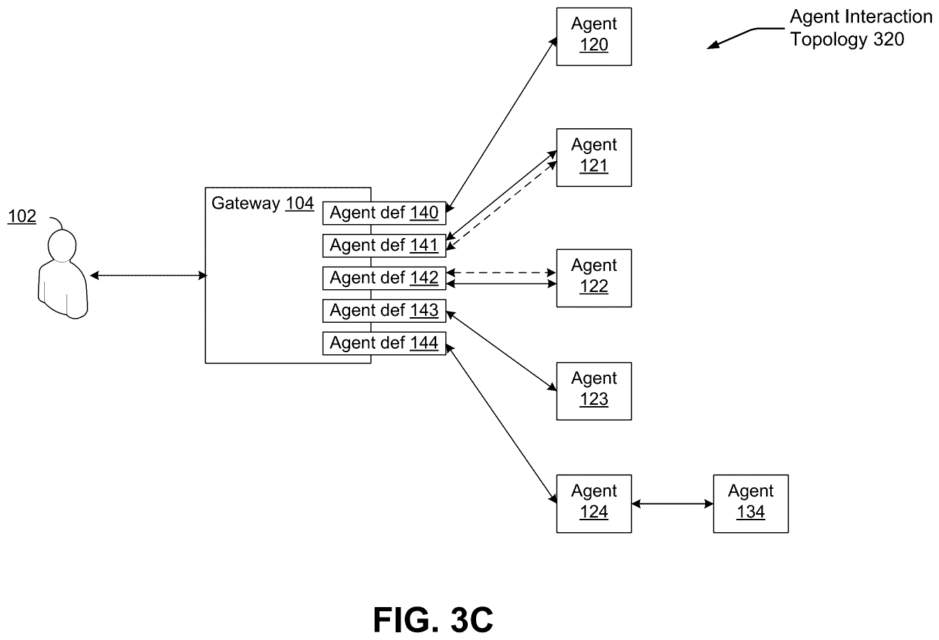

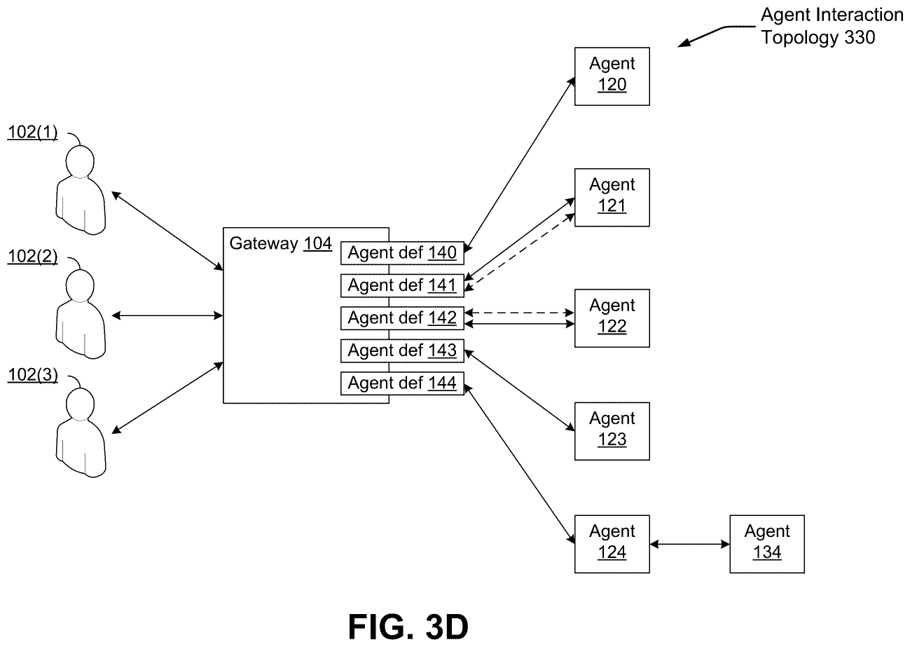

FIG. 3A illustrates an agent interaction topology 300. A single user 102 accesses gateway 104. The gateway uses the agent definition 140 for agent 120 to coordinate interactions between the user and the agent 120. While this agent topology does not necessarily involve distributing a task across multiple agents, this agent topology can still utilize agent selection 106 to select the agent for the user. This agent topology can also use validation rules 110 to ensure that the output of the agent complies with any policies specified by the validation rules.

FIG. 3B illustrates an agent interaction topology 310. A single user 102 accesses gateway 104. The gateway uses the agent definition 140 for agent 120 to facilitate interactions between the user and the agent 120, uses the agent definition 141 for agent 121 to facilitate interactions between the user and the agent 121, uses the agent definition 142 for agent 122 to facilitate interactions between the user and the agent 122, uses the agent definition 143 for agent 123 to facilitate interactions between the user and the agent 123, and uses the agent definition 144 for agent 124 to facilitate interactions between the user and the agent 124. Note that the gateway does not necessarily use all of the agents for every interaction but can select individual agents depending on specified user intent relating to a given task or subtask.

FIG. 3C illustrates an agent interaction topology 320. A user 102 access gateway 104. The gateway uses the agent definition 140 for agent 120 to facilitate interactions between the users and the agent 120, uses the agent definition 141 for agent 121 to facilitate interactions between the user and the agent 121, uses the agent definition 142 for agent 122 to facilitate interactions between the user and the agent 122, uses the agent definition 143 for agent 123 to facilitate interactions between the user and the agent 123, and uses the agent definition 144 for agent 124 to facilitate interactions between the users and the agent 124. In addition, agent 121 and agent 122 can interact via gateway 104, e.g., a parameter output by agent 121 can be input to agent 122 and/or vice-versa.

FIG. 3D illustrates an agent interaction topology 330. User 102(1), user 102(2), and user 102(3) can access gateway 104. The gateway uses the agent definition 140 for agent 120 to facilitate interactions between the users and the agent 120, uses the agent definition 141 for agent 121 to facilitate interactions between the users and the agent 121, uses the agent definition 142 for agent 122 to facilitate interactions between the users and the agent 122, uses the agent definition 143 for agent 123 to facilitate interactions between the users and the agent 123, and uses the agent definition 144 for agent 124 to facilitate interactions between the users and the agent 124. In addition, agent 121 and agent 122 can interact via gateway 104, a parameter output by agent 121 can be input to agent 122 and/or vice-versa. Note that in this agent interaction topology, a user input from one user (e.g., user 102(1)) that is provided to one agent (e.g., agent 121) could result in output that is input to another agent (e.g., agent 122). Then, the output of the other agent could be provided to a different user (e.g., user 102(2)) than the user that provided the initial input. This allows for multi-user, multi-agent scenarios where the users collectively can perform an overall task where individual users request related subtasks and the gateway coordinates performance of the different subtasks by different agents.

### Example User Experience

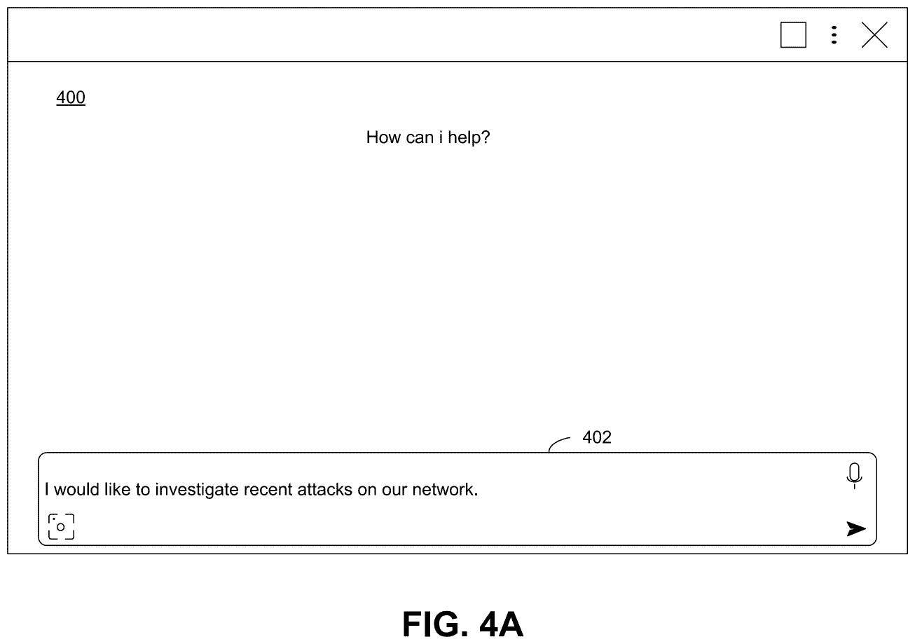

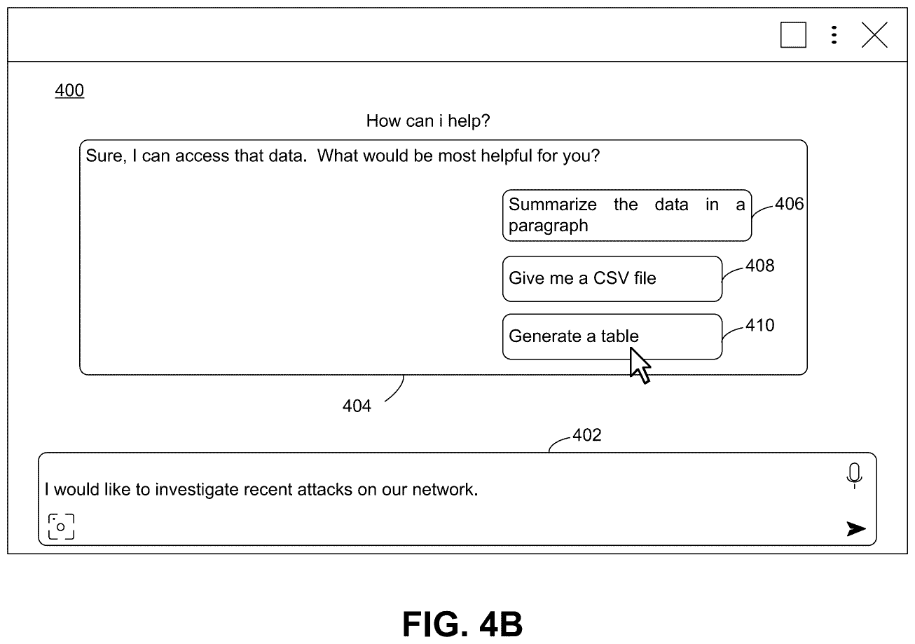

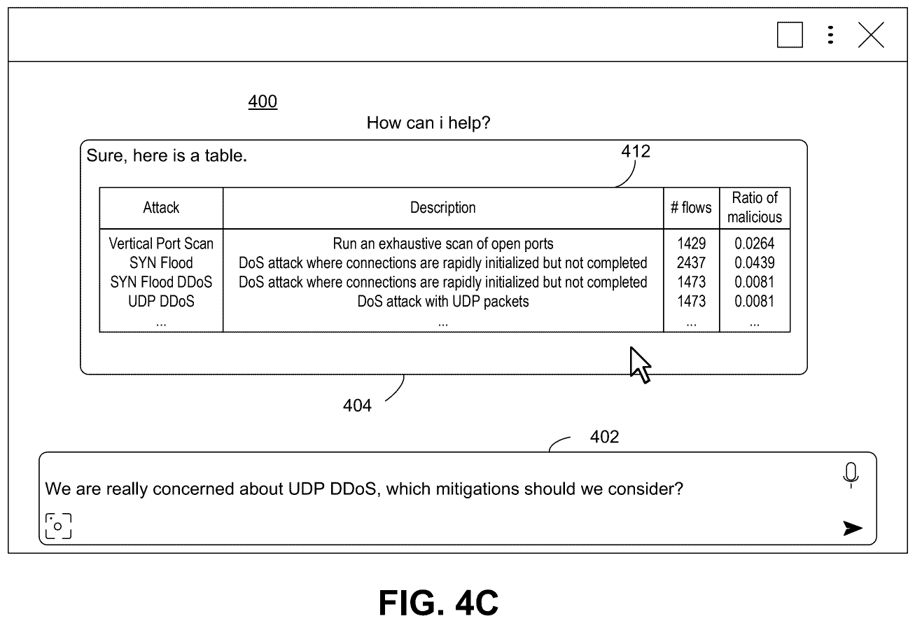

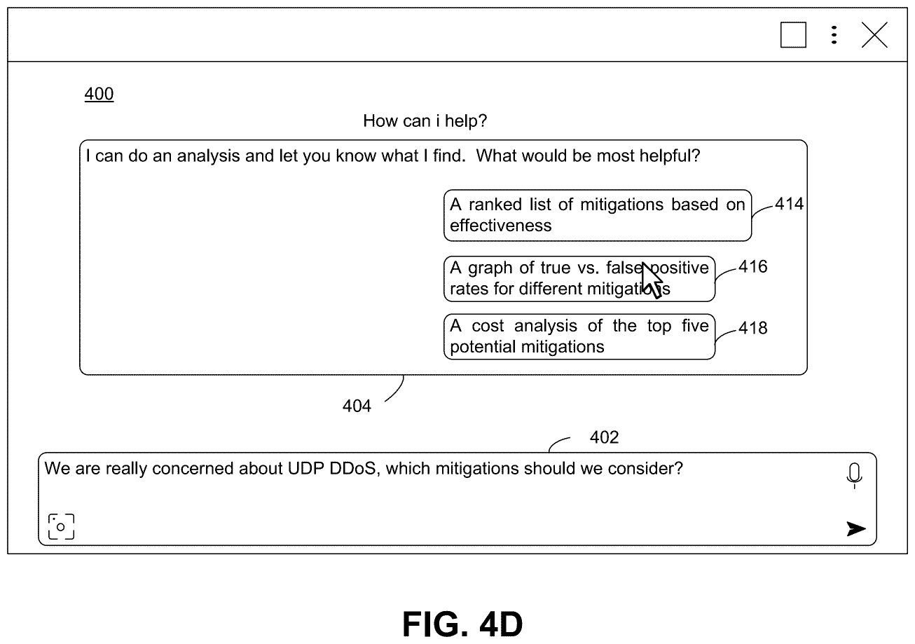

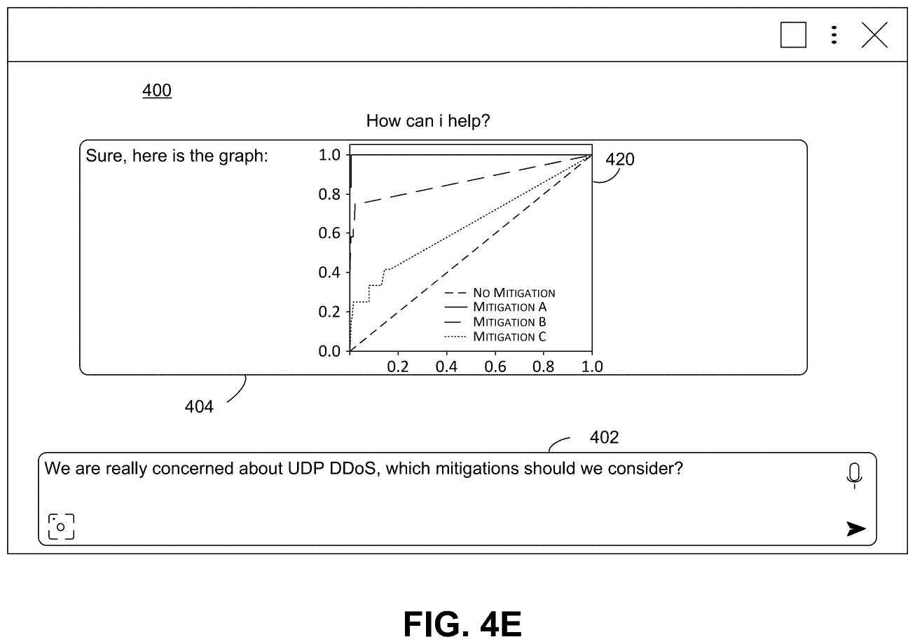

For the following example, assume that agent 120 provides generative language capabilities for conversing with a user, and thus gateway 104 uses agent 120 for conducting a dialog with a user. FIG. 4A shows a user interface 400 with a user input area 402. Here, the user inputs “I would like to investigate recent attacks on our network.” The gateway performs classification on this input and determines that the user intent relates to accessing network data and performing a technical analysis. Then, the gateway prompts the agent 120 with the user input and capabilities of respective agents.

Next, FIG. 4B shows user interface 400 updated with a response 404. The response states “Sure, I can access that data. What would be most helpful for you?” and includes three options. Option 406 offers the user a summary of the data in paragraph form, option 408 offers the user a comma-separated value file, and option 410 offers the user a table. Here, the gateway 104 has determined that, given the user intent and the capabilities of the other available agents as provided by their respective agent definitions, these are three likely subtasks that the user would like to have performed.

Assume the user selects option 410. User interface 400 is updated as shown in FIG. 4C, with a table 412. Here, the user input selecting option 410 can be used to select another agent (e.g., agent 121) that has the ability to access the network data and generate a table summarizing the table. After viewing the table, the user inputs “We are really concerned about UDP DDoS, which mitigations should we consider?” and enters the request.

Next, in FIG. 4D, the response states “I can do an analysis and let you know what I find. What would be most helpful?” and offers the user three options. Option 414 offers the user a list, option 416 offers the user a graph, and option 418 offers the user a cost analysis. Here, the gateway 104 has determined that, given the user intent and the capabilities of the other available agents as indicated by their respective agent definitions, these are three likely subtasks that the agents can provide, and that the user would like to have performed.

Assume the user selections option 416. User interface 400 is updated with a graph 420, as shown in FIG. 4E. Here, the user input selecting option 416 can be used to select another agent (e.g., agent 122) that has the ability to access the network data and generate a graph representing the true vs. false positive rate of the various mitigations. In other cases, the user can provide the network to the gateway 104 (e.g., via shared memory 150) and forward the network data to agent 122, instead of having agent 122 directly access the network data.

Note that the user experience provided above can involve various agent interactions coordinated by gateway 104. For instance, the gateway can use agent 120 to conduct low-latency, conversational dialog with the user to extract user intent. Based on the extracted user intent, the gateway can determine that the user wishes to analyze a specific network data set, which can be stored in shared memory 150. The gateway can then determine that the user wishes to have the data put into a table form, which can be performed by agent 121. Then, the gateway can input the table generated by agent 121 to agent 122 to generate the graph.

In this manner, the user is provided with a single chat history and does not need to directly interact with the underlying agents. Rather, the gateway 104 handles all of the agent interactions on behalf of the user, generating prompts, extracting outputs from one agent and sharing with another agent, etc. From the user's perspective, it can appear as if the user is interacting with a single agent that conducts the dialog, generates the table, generates the graph, etc. In addition, the user does not necessarily need to understand prompting strategies or different capabilities of the selected agents, as these are handled by the gateway.

### Example Evaluation Workflow

Some implementations can use one or more evaluation metrics to evaluate agent interactions. These metrics can be employed for various purposes, such as updating the weights in agent graph 200. For example, the following metrics can be employed. For the following examples, assume a ground truth response is available for a given response output by a particular agent.

First, a semantic similarity metric measures how closely the generated response aligns with the ground truth at a conceptual level. It evaluates the closeness of meaning rather than exact word match. This metric can be defined as a cosine similarity between an embedding representing the response generated by a given agent and an embedding representing the ground truth response. A score of 1 indicates perfect semantic alignment, while 0 indicates no semantic overlap.

Second, an answer correctness metric can be defined by extracting claims from the generated response. Then, the number of claims from the agent output that match corresponding claims in the ground truth can be divided by the total number of claims output by the agent. This metric can be employed to mitigate agent hallucinations.

Third, an answer completeness metric can measure whether the response generated by an agent covers all of the claims from the ground truth. This value can be obtained by determining the number of claims output by the agent that match a corresponding claim in the ground truth, and dividing that number by the total number of in the ground truth. This metric can help evaluate whether the agent response is incomplete, e.g., is missing claims present in the ground truth.

The three metrics described above can be combined to produce an overall accuracy score:

$$Accuracy = α \times SS + β \times C + γ \times COMP$$

α, β, γ are hyper parameters satisfying α+β+γ=1, SS is the semantic similarity metric, C is the correctness metric, and COMP is the completeness metric. These hyper parameters enable the overall accuracy score to be flexibly adapted to different priorities.

The above metrics can be computed for each agent interaction by retrieving embeddings representing each agent interaction and ground truth response. However, this can be somewhat computationally intensive. Thus, an alternative can employ a generative language model as an evaluation model to estimate an accuracy score, as described below.

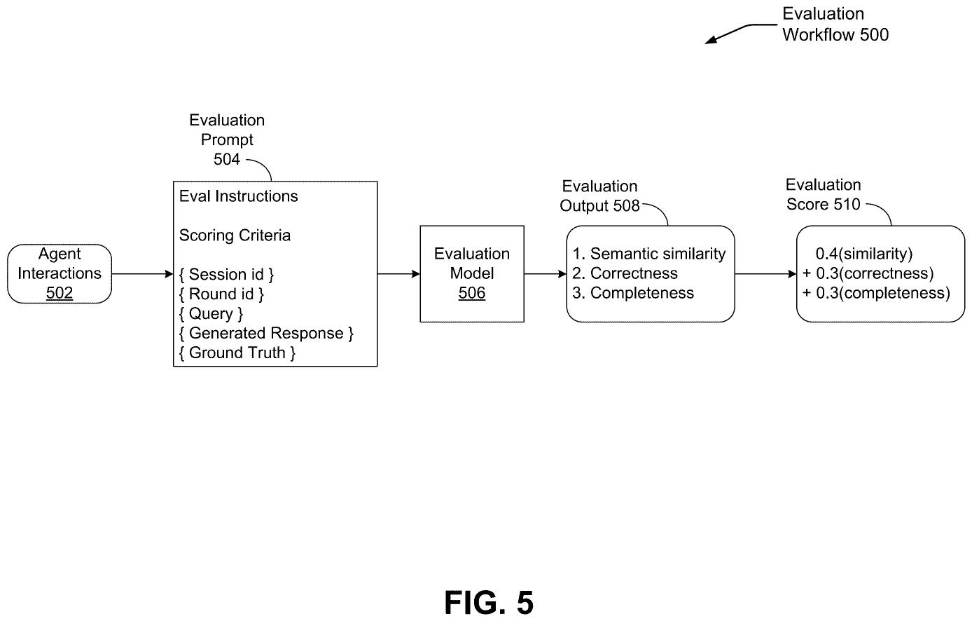

FIG. 5 shows an evaluation workflow 500 that can be employed in this regard. Agent interactions 502 are processed to obtain an evaluation prompt 504. For instance, in some cases, agent interactions are parsed into various JSON (JavaScript Object Notation) fields such as session_id, agent_id, queries, responses, etc. These fields are used to populate an evaluation prompt that specifies the mathematical expressions described above as natural language instructions.

Next, the evaluation prompt 504 is input to an evaluation model 506, such as a generative language model. The evaluation model produces evaluation output 508. For example, the evaluation output can include the three metrics defined above (semantic similarity, correctness, and completeness). Each metric can be accompanied by corresponding explanations based on the criteria defined in the evaluation prompt.

Next, the evaluation output can be processed to obtain an evaluation score 510. This can involve applying the hyperparameters mentioned above to the estimated metrics output by the evaluation model. Thus, while the evaluation model determines the values of the estimated metrics, a user can still control the relative weight that the individual metrics contribute to the final accuracy score.

### Example System

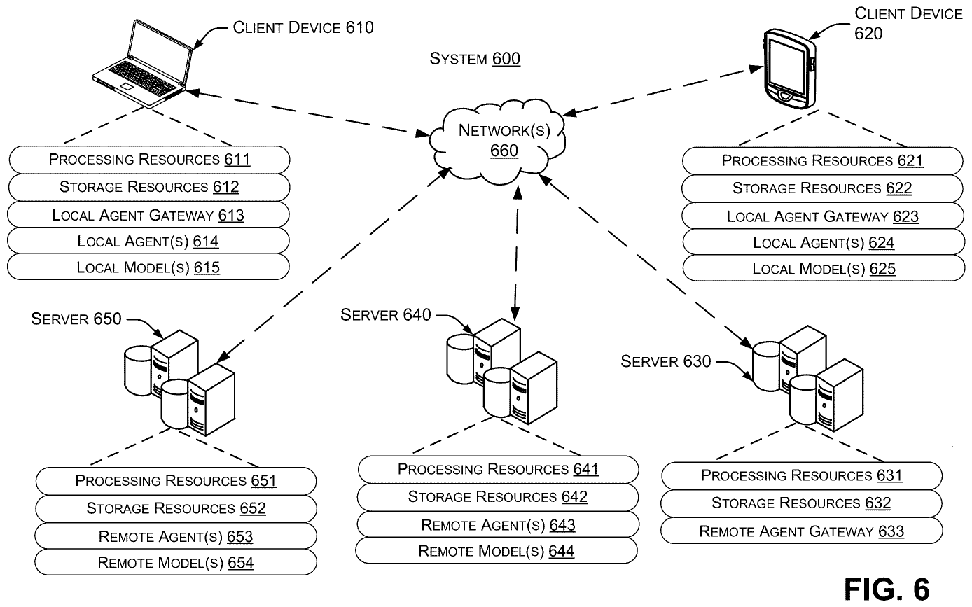

The present implementations can be performed in various scenarios on various devices. FIG. 6 shows an example system 600 in which the present implementations can be employed, as discussed more below.

As shown in FIG. 6, system 600 includes a client device 610, a client device 620, one or more server(s) 630, one or more server(s) 640, and one or more server(s) 640, connected by one or more network(s) 660. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 6, but particularly the servers, can be implemented in data centers, server farms, etc.

Client device 610 can have processing resources 611 and storage resources 612, client device 620 can have processing resources 621 and storage resources 622, server(s) 630 can have processing resources 631 and storage resources 632, server(s) 640 can have processing resources 641 and storage resources 642, server(s) 640 can have processing resources 641 and storage resources 642, and server(s) 650 can have processing resources 651 and storage resources 652. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 610 can include a local agent gateway 613, one or more local agents 614, and one or more local model(s) 615. Client device 620 can include a local agent gateway 623, one or more local agents 624, and one or more local model(s) 625. Server(s) 630 can host a remote agent gateway 633. Server(s) 640 can host one or more remote agent(s) 643 and one or more remote model(s) 644. Server(s) 640 can host one or more remote agent(s) 643 and one or more remote model(s) 644, and server(s) 650 can host one or more remote agent(s) 653 and one or more remote model(s) 654.

The respective local and remote agents can implement agent functionality as described above. For instance, each agent can provide generative machine learning capabilities via machine learning models on the same device as that agent or on a different device. The respective gateways can coordinate agent interactions as also described previously. For example, local agent gateway 613 on client device 610 can facilitate agent interactions with local agent(s) 614 on client device 610, local agent(s) 624 on client device 620 (e.g., peer-to-peer), remote agent(s) 643 on server 640, and/or remote agent(s) 653 on server 650. As another example, remote agent gateway 633 on server 630 can facilitate agent interactions by users of client device 610 and/or client device 620 with local agent(s) 614 on client device 610, local agent(s) 624 on client device 620, remote agent(s) 643 on server 640, and/or remote agent(s) 653 on server 650.

### Example Method

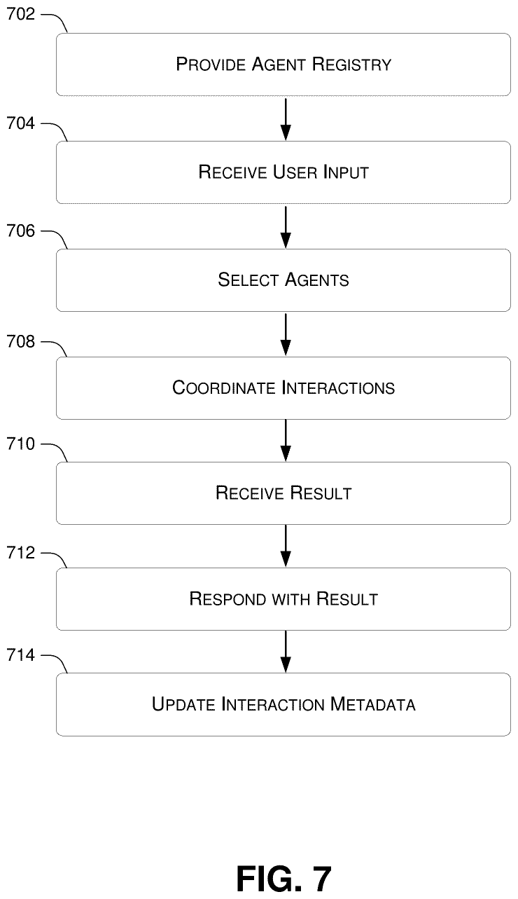

FIG. 7 illustrates an example computer-implemented method 700, consistent with some implementations of the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where an agent registry is provided. For instance, the agent registry can include agent definitions that identify capabilities of respective agents, such as generative machine learning capabilities. The agent definitions can also identify endpoints (e.g., a network address or resource locator) of respective agents, context window limitations, communication templates, etc.

Method 700 continues at block 704, where user input is received. For instance, the user input can include text input, voice input, gaze, gestures, user-selected files, etc. The user input can relate to a particular task that the user is requesting to be performed.

Method 700 continues at block 706, where agents are selected to perform the task for the user based on the agent definitions in the agent registry. For instance, the user input can be classified to infer a user intent, and then the user intent can be used to select the agent(s) to perform the task. In some cases, the task can include different subtasks, and different agents are selected to perform individual subtasks. The agents can be selected according to an agent graph that includes interaction metadata relating to previous interactions involving the respective agents represented by the agent graph.

Method 700 continues at block 708, where interactions with the selected agents are coordinated. For instance, the user input can be processed by gateway 104 to extract parameters, and the parameters can be provided to the respective endpoints of the selected agents consistent with application programming interfaces and/or communication templates that indicate how to communicate with the selected agents. The interactions can also involve direct agent-to-agent interactions, where two or more agents communicate directly with one another to obtain a result that is then forwarded to the gateway 104.

Method 700 continues at block 710, where a result of the particular task is received. For instance, the result can be a final result or an intermediate result, e.g., the table 412 in FIG. 4C can be an intermediate result and the graph 420 can be a final result that the user is seeking via interaction with the gateway.

Method 700 continues at block 712, where result is output. For instance, as noted above, the result can be output via a chat interface that provides a unified chat history of interactions with multiple selected agents.

Method 700 continues at block 714, where interaction metadata is updated. For instance, intermediate and/or final results output by a given agent can be used to determine a score for that agent and/or infer capabilities of that agent.

In some implementations, providing the agent registry at block 702 can be implemented during an initial deployment phase. Subsequently, blocks 704 through 714 can be implemented during a separate execution phase. However, in other implementations, the deployment and execution phases are not necessarily separate phases performed sequentially, but rather the agent registry can be intermittently or continually updated based on agent interactions and the updated agent registry can be provided to users for subsequent iterations of method 700.

### Additional Implementations

The examples introduced above provide an overview of the disclosed concepts. The following section describes additional scenarios that can be provided.

As noted above, individual agents can have different capabilities. One agent may provide conversational natural language capabilities, another agent may have vision language capabilities for extracting captions describing objects in an image, and a third agent may have scientific capabilities relating to a specific branch of science, such as biology. Consider a user that wishes to understand the ecosystem conveyed in an image that includes various plants and animals. The user may generally be aware of the conversational capabilities of the first image but may be unaware even of the existence of the second and third agents. Furthermore, the second and/or third agents may not have intuitive user interfaces and instead may rely on programmatic interfaces for interactions.

Here, the user can access gateway 104 and provide an input such as “I want to know more about the ecosystem in this picture.” The first agent can conduct a dialog with the user via the gateway. The gateway can then provide the picture to the second agent via an API call and/or using a communication template specifying a format of how to prompt the second agent and receive various parameters from the second agent identifying animals present in the image, plants present in the image, etc. The gateway may receive the parameters via a response to the API call, by a text output of the second agent formatted according to the communication template, etc. The gateway can then provide those parameters to the third agent according to another API and/or communication template associated with the third agent and receive a response from the third agent including further parameters describing the ecosystem. The gateway can prompt the first agent based on the identified ecosystem to generate a narrative description of that ecosystem.

If the agent interactions are positive, e.g., score highly according to the accuracy score metric outlined above, then the agent graph can be updated. The interaction metadata for each of the agents can be updated to convey any new capabilities identified by the interactions. In addition, edge weights can be increased between the agents. Thus, the next time a user has a query relating to biological questions about an image, the gateway 104 can be more likely to select the first, second, and third agents for that query as well.

On the other hand, assume one of the agent interactions is not satisfactory. For instance, assume the second agent identifies a generic plant (e.g., grass) instead of a specific species (e.g., arctic meadow grass). This may be a semantically correct answer, but since grasses grow in many ecosystems it may be insufficiently precise for the third agent to determine the correct ecosystem. Thus, the edge weight from the second agent to the third agent could be decreased, making it less likely that the gateway would choose the combination of the second and third agent for a future query.

As another point, consider context window limitations. In the example above, the third agent could have a small context window because it is designed to classify ecosystems based on a relatively small input—a list of species. On the other hand, the second agent could have a tendency to generate very large descriptions of images, e.g., a robust, detailed description of every single object in the image. In this case, the gateway 104 could prompt the first agent to extract only the identified species from the second agent before prompting the third agent. This could reduce the input to the third agent to fit within the context window and also filter out extraneous information that could cause the third agent to hallucinate or otherwise give an incorrect answer.

In addition, the use of an agent graph 200 can facilitate effective selection of agents to perform individual tasks or subtasks, even in an environment with rapidly-changing agent capabilities. For instance, as new agents come online or gain new capabilities, the agent registry 145 can be updated with definitions that convey this information. Then, the agent graph can be updated to reflect the new information identified in the agent registry. As a consequence, the next time a user requests that a task is performed, the most recent agent capabilities and/or interactions can be used as a basis for selecting a path through the agent graph to identify the agent(s) to perform that task for the user.

In addition, various techniques can be used to traverse the agent graph. For instance, consider an A* search where the gateway designates a starting point to perform an initial subtask for a user (e.g., node 210) and an ending point to perform a final subtask for a user (e.g., node 214). In one case, the traversal might go through one set of intermediate nodes and another traversal might go through another set of intermediate nodes after the edge weights have been updated.

As another aspect to consider, some agents may exhibit relatively high latency. For instance, the table 412 shown in FIG. 4C may be generated from a vast registry of network data, on the order of gigabytes of individual records. The agent that generates this table may need to make many, many network calls and computations to summarize the network data in a short table that is readily understandable by a human user. However, the user could still conduct a chat conversation with other agents via the gateway 104, and the gateway could extract additional user intents and/or invoke other agents while waiting for the table to created. Thus, from the user's perspective, a low-latency and responsive experience can be provided while still utilizing agents that perform very intense, long-running calculations.

As still another aspect, one validation rule may involve validating that a given agent output does not include inappropriate content. For instance, one agent may have a very high temperature setting that allows that agent to act more creatively, with fewer bounds on the output by that agent. This could occasionally cause scenarios where that agent produces inappropriate output, e.g., violent text and/or images. A compliance rule could specify that another agent (e.g., a natural language or computer vision model) should evaluate content generated by the first agent before providing that content to the user. A redirect rule could specify using another agent when the content generated by the first agent is not validated.

As still another aspect, some agents may have limitations on accessing certain content. For instance, one agent may be implemented using confidential compute capabilities that allow that agent to process private user data, while another agent may be implemented using less-secure technologies that potentially allow information leakage. Thus, a compliance rule may require that the second agent does not process private user data. The gateway 104 could ask the first agent to summarize or redact private user data to comply with this rule.

As another point, consider intent classification. One way to classify user intent involves using a dedicated intent classifier, e.g., a local model based on a text encoder with an intent classification layer. Another way to do so involves asking a generative language model to classify user intent. In a third case, user intents could be validated by first using a model to predict user intent and then prompting the user to validate the predicted intent before proceeding.

As an additional point, the use of shared memory can facilitate collaborative interactions among multiple users and multiple agents that involve generation of multi-modal output. For instance, assume a first user prompts an agent that provides generative image capabilities to produce an image of a fantasy scene that shows a wizard riding a dragon. A second user could request that same agent to modify the appearance of the dragon, and then a third user could request that an agent with vision-language capabilities generate a descript of the wizard and the dragon. Then, a fourth user could ask an agent that provides natural language generation capabilities to write a story about the wizard and the dragon. Then the first user could ask the agent with generative image capabilities to generate a video or sequence of images depicting the generated story. In this case, the shared memory can store the images, text, etc., as well as session data corresponding to the various user inputs and model outputs. The agent interaction database 154 can be updated to reflect the agent interactions, which can be propagated to the agent registry 145 and/or agent graph 200.

With respect to the agent interaction database 154, some implementations can employ a vector database implementation. User input, user files, inputs to agents, and/or outputs generated by agents can be mapped to corresponding vector embeddings in a semantic space. Then, the gateway 104 can use the embeddings to retrieve individual data items from the database for further processing by individual agents. For instance, assume a first agent searches the internet to retrieve a number of images in response to a request from a first user, and only one of the downloaded images shows a wheelbarrow. The database can store vector representations of objects identified in each image by a computer vision model. Subsequently, if a second user mentions the term “wheelbarrow” in speech or text, a text encoder can map that term to a corresponding embedding to retrieve the image with the wheelbarrow. For instance, the second user may request to modify the downloaded image with the wheelbarrow. Then, the gateway 104 can request another agent with generative image capabilities to make the requested modifications to the downloaded image by retrieving that image from the database and sending that image to the other agent with a prompt requesting the modifications. Thus, the second user is able to obtain a modified image using text or speech to refer to the downloaded image that they wish to modify without having to retrieve the downloaded image themselves, e.g., by navigating a file folder. This can facilitate collaborative agent interactions because it allows one user to refer to data generated for or provided by another user during the source of a collaborative session involving multiple users and multiple agents.

### Technical Effect

As noted previously, many agents have specific capabilities and specific API's, communication patterns, and/or context window limitations. As a consequence, in many cases, two or more agents cannot interoperate with one another effectively. For instance, generative language output by one agent may be far too descriptive and/or in an incorrect format for prompting a generative image model. Naively propagating output from the first agent to the second agent could cause hallucinations or otherwise incorrect generated image content.

The disclosed implementations employ a gateway to act as an intermediary that coordinates interactions among users and agents in a manner that accounts for these technical limitations among agents. For instance, the gateway can ensure that requests to a given agent comply with an API or communication pattern used by that agent, fit within context window size associated with that agent, and so on. In addition, the gateway can pass parameters generated by one agent in one format (e.g., natural language) in a different format expected by another agent (e.g., a JSON structure).

Furthermore, the use of a shared memory to store data relating to an ongoing task can ensure that each agent has the appropriate context for performing a given task. Generally, the inputs provided by various users and/or outputs by individual agents can be stored in the shared memory. Information stored therein can be selectively retrieved and provided to individual agents as context associated with a given request during a given session. Thus, the agents are not acting in isolation from one another, but rather the entire history of interactions between the users and agents can be used as a basis to guide content generation by respective agents. Furthermore, while the entire history of interactions is available, only a relevant subset of data from the interaction history can be retrieved as context for individual calls to individual agents. Thus, the agents themselves do not necessarily have the entire interaction history as context, but only the pertinent information from the interaction history relating to a given subtask that agent is requested to perform. This can preserve bandwidth, processing, and/or memory resources that would otherwise be employed to provide the entire interaction history as context, while also reducing the likelihood of hallucinations and ensuring compliance with context window limitations of individual agents.

### Example Decoder-Based Generative Language Model

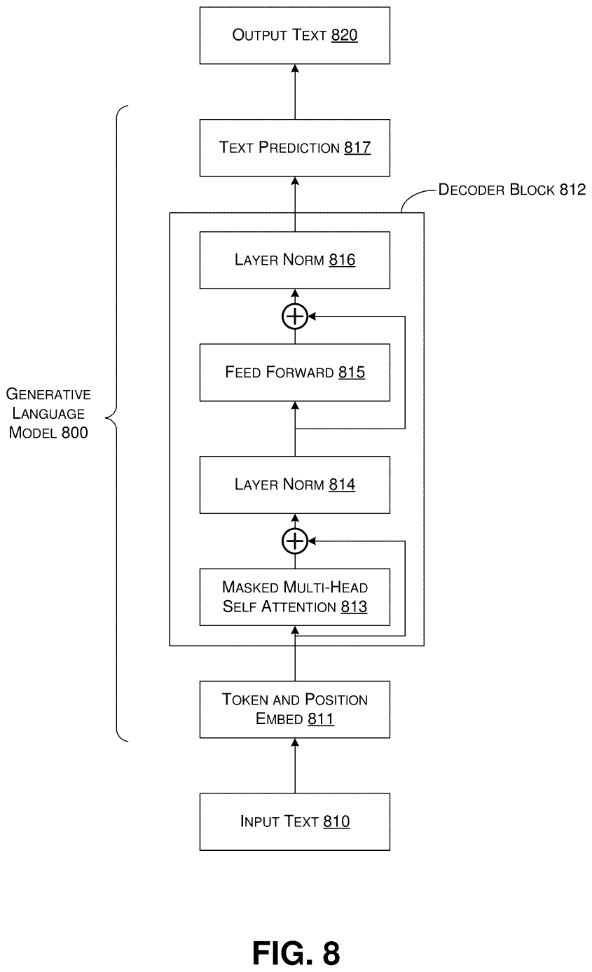

FIG. 8 illustrates an exemplary generative language model 800 (e.g., a transformer-based decoder) that can be employed using the disclosed implementations. (Radford, et al., “Improving language understanding by generative pre-training,” 2018). Generative language model 800 is an example of a machine learning model that can be used to perform one or more natural language processing tasks that involve generating text, as discussed more below. For the purposes of this document, the term “natural language” means language that is normally used by human beings for writing or conversation.

Generative language model 800 can receive input text 810, e.g., a prompt from a user or a prompt generated automatically by machine learning using the disclosed techniques. For instance, the input text can include words, sentences, phrases, or other representations of language. The input text can be broken into tokens and mapped to token and position embeddings 811 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 811 are processed in one or more decoder blocks 812. Each decoder block implements masked multi-head self-attention 813, which is a mechanism relating different positions of tokens within the input text to compute the similarities between those tokens. Each token embedding is represented as a weighted sum of other tokens in the input text. Attention is only applied for already-decoded values, and future values are masked. Layer normalization 814 normalizes features to mean values of 0 and variance to 1, resulting in smooth gradients. Feed forward layer 815 transforms these features into a representation suitable for the next iteration of decoding, after which another layer normalization 816 is applied. Multiple instances of decoder blocks can operate sequentially on input text, with each subsequent decoder block operating on the output of a preceding decoder block. After the final decoding block, text prediction layer 817 can predict the next word in the sequence, which is output as output text 820 in response to the input text 810 and also fed back into the language model. The output text can be a newly-generated response to the prompt provided as input text to the generative language model.

Generative language model 800 can be trained using techniques such as next-token prediction or masked language modeling on a large, diverse corpus of documents. For instance, the text prediction layer 817 can predict the next token in a given document, and parameters of the decoder block 812 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Example Generative Image Model

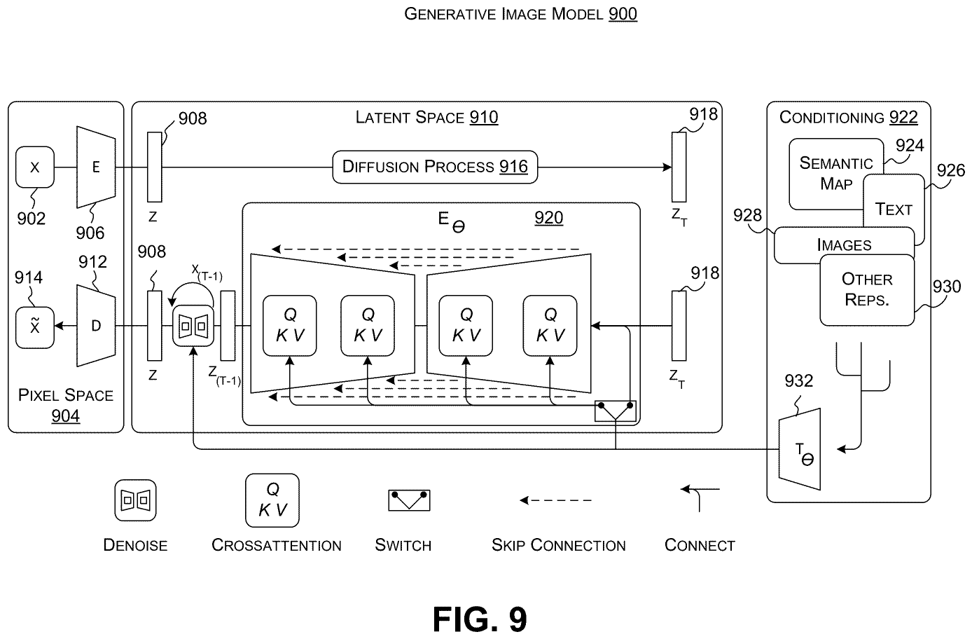

FIG. 9 illustrates an example generative image model 900. An image 902 (X) in pixel space 904 (e.g., red, green, blue) is encoded by an encoder 906 (E) into a representation 908 (Z) in a latent space 910. A decoder 912 (D) is trained to decode the latent representation Z to produce a reconstructed image 914 (X~) in the pixel space. For instance, the encoder can be trained (with the decoder) as a variational autoencoder using a reconstruction loss term with a regularization term.

In the latent space 910, a diffusion process 916 adds noise to obtain a noisy representation 918 (Z_{T}). A denoising component 920 (E_{θ}) is trained to predict the noise in the compressed latent image Z_{T}. The denoising component can include a series of denoising autoencoders implemented using UNet 2D convolutional layers.

The denoising can involve conditioning 922 on other modalities, such as a semantic map 924, text 926, images 928, or other representations 930 which can be processed to obtain an encoded representation 932 (T_{θ}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 900 can be employed for text to image generation, where an image is generated from a text prompt. Text prompts can be provided by users or generated automatically by machine learning using the disclosed techniques. In other cases, generative image model 900 can be employed for image-to-image mode, where an image is generated using an input image as well as a user or machine-generated text prompt. Generative image model 900 can also be employed for inpainting, where parts of an image are masked and remain fixed while the rest of the image is generated by the model, in some cases conditioned on a user or machine-generated text prompt.

In some cases, generative image model 900 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), which can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 900, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image.

Generative image model 900 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that is consistent with the fixed parts of the image. Note that the term “inpainting,” as used herein, includes filling in parts of a given image whereas “outpainting” refers to extending an image outward.

### Example Computer Vision Model

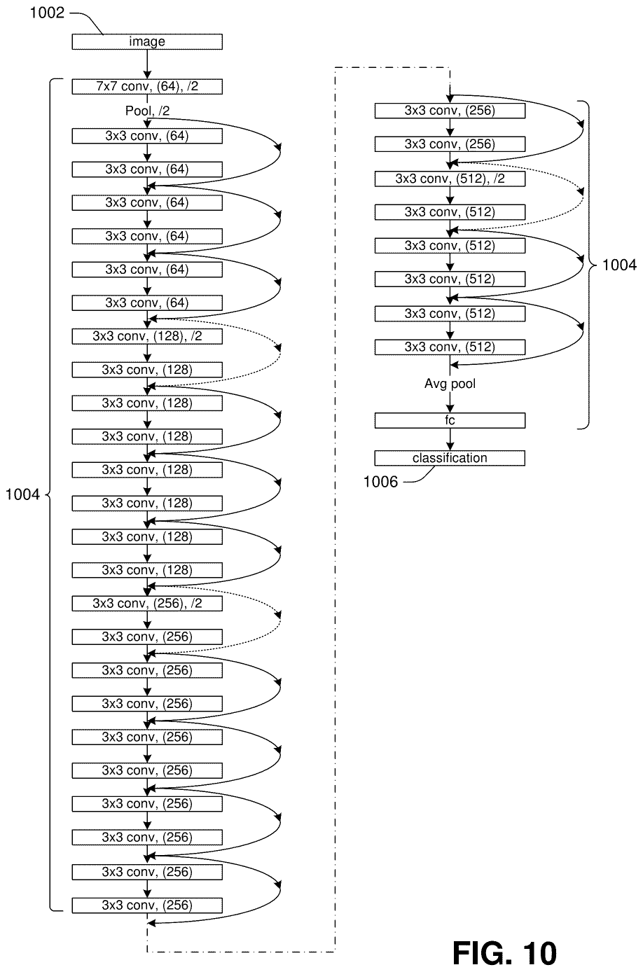

FIG. 10 illustrates a particular example of a neural network model for computer vision. For instance, FIG. 10 shows an image 1002 being classified by a computer vision model 1004 to determine an image classification 1006, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 256, 512). If the feature map size is halved by a given convolutional layer (as shown by “/2” in FIG. 10), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 1002.

The respective layers within computer vision model 1004 can have shortcut connections which perform identity operations:

$$y = F ( x , \{ {W}_{i} \} ) + x \qquad ( 1 )$$

where x and y are the input and output vectors of the layers involved and F(x, {Wᵢ}) represents the residual mapping learned by the model. In some connections the dimensions increase across layers (shown as dotted lines in FIG. 10). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 1004 can be pretrained on a large dataset of images, such as ImageNet. Such a general-purpose image database can provide a vast number of training examples that allow the model to learn weights that allow generalization across a range of object categories. Said another way, computer vision model 1004 can be pretrained in this fashion.

After pretraining, computer vision model 1004 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Example Vision Language Model

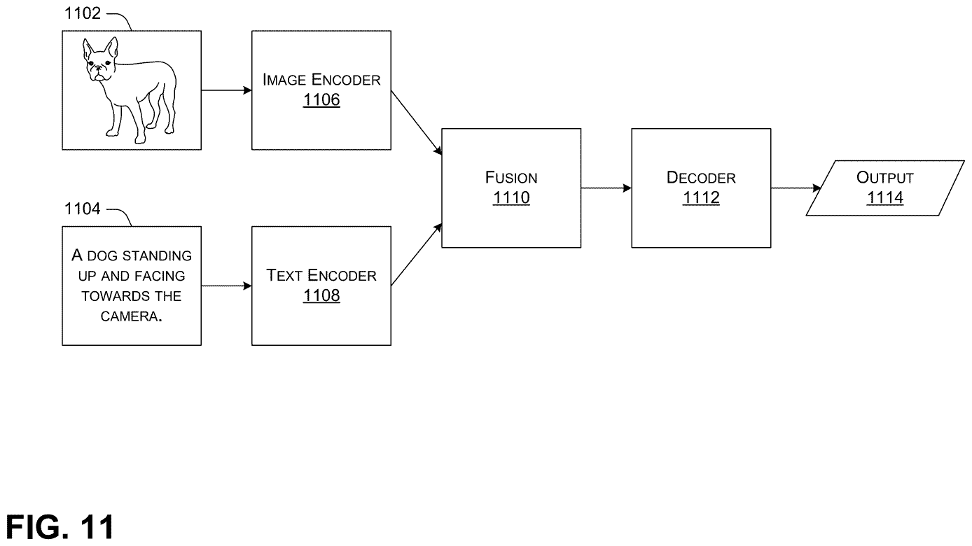

FIG. 11 shows an example vision language model 1100 that can process an input image 1102 and/or a text input 1104. The input image is processed using an image encoder 1106 (e.g., based on computer vision model 1004) and the text input is processed using a text encoder 1108. The image encoder and text encoder produce encodings (e.g., vector embeddings) representing the input image and text input, respectively. A fusion process 1110 can fuse the encodings using techniques such as attention, dot product, etc. A decoder 1112 can decode the fused encodings to produce an output 1114.

In some implementations, the image encoder can also be based on a transformer architecture such as a Vision Transformer (Dosovitskiy, et al., “An Image is Worth 16×16 Words: Transformers for Image Recognition at Scale,” Jun. 3, 2021, arXiv preprint arXiv: 2010.11929v2). The text encoder 1108 can be based on a transformer architecture such as BERT or GPT. In other cases, an “early fusion” approach can employ a shared encoder that processes sequences of text and image tokens using a single encoder that determines embeddings for each text or image token. (Chameleon. Team C, “Chameleon: Mixed-Modal Early-Fusion Foundation Models,” 2024, arXiv preprint, arXiv: 2404.09818).

The vision language model 1100 can be trained using approaches such as contrastive learning, where the training data includes pairs of text and images, and the model is trained to determine whether a given text sample matches a corresponding image sample. In this manner, the image encoder 1106 and the text encoder 1108 can be trained to generate similar embeddings for text and images that represent similar concepts (e.g., the word “bear” and an image of a bear). Other approaches include masked image modeling and/or masked language modeling and image-text modeling.

The output 1114 can characterize an image. For instance, the output can answer a visual question, caption the image, etc. The output can also identify detected objects, classify detected objects, perform image segmentation, etc. In some cases, the vision language model 1100 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc. The output can also specify relationships between detected objects, e.g., “the bear is riding the unicycle in the circus ring,” etc.

### Device Implementations

As noted above with respect to FIG. 6, system 600 includes several devices, including a client device 610, a client device 620, one or more server(s) 630, one or more server(s) 640, and one or more server(s) 640. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 660. Without limitation, network(s) 660 can include one or more local area networks (LANs), wide area networks (WANs), the Internet, and the like.

### Additional Examples

Various device examples are described above. Additional examples are described below. One example includes a computer-implemented method comprising providing an agent registry, the agent registry including agent definitions identifying respective characteristics of a plurality of agents, receiving user input from a user, the user input relating to a particular task requested by the user, responsive to receiving the user input, selecting two or more agents to perform the particular task based at least on respective agent definitions of the two or more selected agents in the agent registry, coordinating interactions with the two or more selected agents in accordance with the respective agent definitions, wherein the interactions relate to the particular task, receiving a result associated with the particular task from an individual selected agent, and responding to the user with the result.

Another example can include any of the above and/or below examples where the agent definitions identify generative machine learning capabilities of individual agents, the generative machine learning capabilities including one or more of generative language capabilities, generative image capabilities, or vision-language capabilities.

Another example can include any of the above and/or below examples where the agent definitions identify respective endpoints of the individual agents.

Another example can include any of the above and/or below examples where the agent definitions identify context window limitations of the plurality of agents and communication templates for communicating with the plurality of agents.

Another example can include any of the above and/or below examples where the method further comprises applying one or more rules when coordinating the interactions with the one or more selected agents.

Another example can include any of the above and/or below examples where the one or more rules relate to validating content output by the one or more selected agents, redirecting requests away from non-compliant agents, or determining whether agent responses are compliant with individual rules.

Another example can include any of the above and/or below examples where the method further comprises classifying an intent associated with the user input and selecting the two or more agents based at least on the classifying.

Another example can include any of the above and/or below examples where the classifying is performed with a machine learning model.

Another example can include any of the above and/or below examples where the classifying identifies a particular generative machine learning capability requested by the user input.

Another example can include any of the above and/or below examples where the method further comprises storing an agent graph having interaction metadata representing past agent interactions and selecting the two or more agents based at least on the interaction metadata in the agent graph.

Another example can include any of the above and/or below examples where the method further comprises updating the interaction metadata based at least on the result of the particular task that is output by the individual selected agent.

Another example includes a system comprising a processor and a storage medium storing instructions which, when executed by the processor, cause the system to provide an agent registry, the agent registry including agent definitions identifying respective characteristics of a plurality of agents, receive user input from a user, the user input relating to a particular task requested by the user, responsive to receiving the user input, select two or more agents to perform the particular task based at least on respective agent definitions of the two or more selected agents in the agent registry, coordinate interactions with the two or more selected agents in accordance with the respective agent definitions, wherein the interactions relate to the particular task, receive a result associated with the particular task from an individual selected agent, and respond to the user with the result.

Another example can include any of the above and/or below examples where the instructions, when executed by the processor, cause the system to provide a unified graphical interface that provides unified interaction between the user and the two or more selected agents.

Another example can include any of the above and/or below examples where the unified graphical interface provides a single chat history with the two or more selected agents.

Another example can include any of the above and/or below examples where the instructions, when executed by the processor, cause the system to employ a shared memory to store agent interactions and pass parameters from a first selected agent to a second selected agent.

Another example can include any of the above and/or below examples where the two or more selected agents include an agent with generative language capabilities or an agent comprising a generative machine learning model.

Another example can include any of the above and/or below examples where the two or more selected agents include an agent with vision-language capabilities and another agent with image generation capabilities.

Another example can include any of the above and/or below examples where the two or more selected agents perform at least one of the interactions directly with one another.

Another example can include any of the above and/or below examples where the instructions, when executed by the processor, cause the system to receive output from a first selected agent, parse the output to extract a parameter, and provide the parameter to a second selected agent, the second selected agent generating the result of the particular task based at least on the parameter.

Another example includes a computer-readable storage medium storing instructions which, when executed by a processing device, cause the processing device to perform acts comprising providing an agent registry, the agent registry including agent definitions identifying respective characteristics of a plurality of agents, receiving user input from a user, the user input relating to a particular task requested by the user, responsive to receiving the user input, selecting two or more agents to perform the particular task based at least on respective agent definitions of the two or more selected agents in the agent registry, coordinating interactions with the two or more selected agents in accordance with the respective agent definitions, wherein the interactions relate to the particular task, receiving a result associated with the particular task from an individual selected agent, and responding to the user with the result.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
providing an agent registry, the agent registry including agent definitions identifying respective characteristics of a plurality of agents;
receiving user input from a user, the user input relating to a particular task requested by the user;
responsive to receiving the user input, selecting two or more agents to perform the particular task based at least on respective agent definitions of the two or more selected agents in the agent registry;
coordinating interactions with the two or more selected agents in accordance with the respective agent definitions, wherein the interactions relate to the particular task;
receiving a result associated with the particular task from an individual selected agent; and
responding to the user with the result.

2. The computer-implemented method of claim 1, wherein the agent definitions identify generative machine learning capabilities of individual agents, the generative machine learning capabilities including one or more of generative language capabilities, generative image capabilities, or vision-language capabilities.

3. The computer-implemented method of claim 2, wherein the agent definitions identify respective endpoints of the individual agents.

4. The computer-implemented method of claim 3, wherein the agent definitions identify context window limitations of the plurality of agents and communication templates for communicating with the plurality of agents.

5. The computer-implemented method of claim 1, further comprising:
applying one or more rules when coordinating the interactions with the one or more selected agents.

6. The computer-implemented method of claim 5, wherein the one or more rules relate to validating content output by the one or more selected agents, redirecting requests away from non-compliant agents, or determining whether agent responses are compliant with individual rules.

7. The computer-implemented method of claim 1, further comprising:
classifying an intent associated with the user input; and
selecting the two or more agents based at least on the classifying.

8. The computer-implemented method of claim 7, the classifying being performed with a machine learning model.

9. The computer-implemented method of claim 8, wherein the classifying identifies a particular generative machine learning capability requested by the user input.

10. The computer-implemented method of claim 9, further comprising:
storing an agent graph having interaction metadata representing past agent interactions; and
selecting the two or more agents based at least on the interaction metadata in the agent graph.

11. The computer-implemented method of claim 10, further comprising:
updating the interaction metadata based at least on the result of the particular task that is output by the individual selected agent.

12. A system comprising:
a processor; and
a storage medium storing instructions which, when executed by the processor, cause the system to:
provide an agent registry, the agent registry including agent definitions identifying respective characteristics of a plurality of agents;
receive user input from a user, the user input relating to a particular task requested by the user;
responsive to receiving the user input, select two or more agents to perform the particular task based at least on respective agent definitions of the two or more selected agents in the agent registry;
coordinate interactions with the two or more selected agents in accordance with the respective agent definitions, wherein the interactions relate to the particular task;
receive a result associated with the particular task from an individual selected agent; and
respond to the user with the result.

13. The system of claim 12, wherein the instructions, when executed by the processor, cause the system to:
provide a unified graphical interface that provides unified interaction between the user and the two or more selected agents.

14. The system of claim 13, the unified graphical interface providing a single chat history with the two or more selected agents.

15. The system of claim 14, wherein the instructions, when executed by the processor, cause the system to:
employ a shared memory to store agent interactions and pass parameters from a first selected agent to a second selected agent.

16. The system of claim 13, the two or more selected agents including an agent with generative language capabilities or an agent comprising a generative machine learning model.

17. The system of claim 13, the two or more selected agents including an agent with vision-language capabilities and another agent with image generation capabilities.

18. The system of claim 13, wherein the two or more selected agents perform at least one of the interactions directly with one another.

19. The system of claim 13, wherein the instructions, when executed by the processor, cause the system to:
receive output from a first selected agent;
parse the output to extract a parameter; and
provide the parameter to a second selected agent, the second selected agent generating the result of the particular task based at least on the parameter.

20. A computer-readable storage medium storing instructions which, when executed by a processing device, cause the processing device to perform acts comprising:
providing an agent registry, the agent registry including agent definitions identifying respective characteristics of a plurality of agents;
receiving user input from a user, the user input relating to a particular task requested by the user;
responsive to receiving the user input, selecting two or more agents to perform the particular task based at least on respective agent definitions of the two or more selected agents in the agent registry;
coordinating interactions with the two or more selected agents in accordance with the respective agent definitions, wherein the interactions relate to the particular task;
receiving a result associated with the particular task from an individual selected agent; and
responding to the user with the result.
